(19) United States
(12) Patent Application Publication
(10) Pub. No.: US 2018/0039949 A1
(43) Pub. Date: Feb. 8, 2018

(54) OPTIMIZING AND SYNCHRONIZING PEOPLE FLOWS

(71) Applicant: SAP Portals Israel Ltd., Ra'anana (IL)

(72) Inventors: Nirit Cohen-Zur, Ra'anana (IL); Rachel Ebner, Ra'anana (IL); Itai Fonio, Tel Aviv (IL)

(21) Appl. No.: 15/225,958

(22) Filed: Aug. 2, 2016

(51) Int. Cl. G06Q 10/10

(52) U.S. Cl. CPC G06Q 10/1095

(57) ABSTRACT

The disclosure generally describes methods, software, and systems, including a method for optimizing people flows. User preferences and a user context are received. Resource information is accessed for resources to be used by the user and other users during participation in a multi-human activity scenario. Optimizations are generated based on the user preferences, user context, and resource information. The optimizations include best start times for the user and other users and is generated based on current resource loads and expected times of use. The optimizations include, for a given resource-user pair, locations, times, and events, each event associated with a separate user task at a given resource. A schedule, provided to the user, includes the best start time and, for each resource assigned to the user, a time, a location, and an event schedule indicating mandatory, preferred and optional times and sub-locations of the events.

### BACKGROUND

The present disclosure relates to schedules for people and the use of resources.

Some businesses and other entities can have large numbers of customers. The customers may decide to use resources of the businesses at different times. For example, an airport may include check-in counters, security stations, baggage claim, and other resources. The order in which passengers and other customers use these resources and the amount of people using them at one time can effect overall efficiency of the airport and the amount of time wasted, such as in lines.

### SUMMARY

The disclosure generally describes computer-implemented methods, software, and systems for optimizing and synchronizing people flows. One computer-implemented method includes: receiving, over a computer network, user preferences associated with a user, wherein the user preferences include user-desired conditions and constraints of participation by the user in a multi-human activity scenario; storing the user preferences in an electronic database; receiving, over the computer network, a user context associated with the user; accessing, by one or more processors, resource information for resources associated with the multi-human activity scenario, each resource to be used by, or available to, the user and the other users during participation in the multi-human activity scenario; generating, by the one or more processors and based on the stored user preferences, the received user context, and the accessed resource information, optimizations for the multi-human activity scenario, the optimizations including a best start time for the user and best start times for other users, wherein the optimizations are generated based on current loads of the resources and expected times of use of the resources by the user and the other users, wherein the optimizations include, for a given resource-user pair, one or more sets of locations, times, and events, each event associated with a separate task of the user at a given resource; and providing, to the user over the computer network, a schedule that includes the best start time and, for each resource assigned to the user, a time, a location, and an event schedule indicating mandatory, preferred and optional times and sub-locations of the events.

The foregoing and other implementations can each optionally include one or more of the following features, alone or in combination. In particular, one implementation can include all the following features:

In a first aspect, combinable with any of the previous aspects, the method further comprises receiving information associated with one or more of resource availability, staffing conditions of the resources, weather conditions associated with the multi-human activity scenario, traffic conditions for routes near or associated with the multi-human activity scenario, and a health condition of the user; and wherein generating the optimizations includes evaluating the information, including historical information, recent conditions, current conditions, and predicted conditions.

In a second aspect, combinable with any of the previous aspects, the multi-human activity scenario is an airport; the best start time is a time at which the user is to leave for the airport; the resources include an airport facility, airline carriers using the airport facility, security gates at the airport facility, parking facilities, ground transportation, highways, and businesses; and generating the optimizations further includes evaluating applicable ones of airline schedules, estimated airline arrivals and departures, parking availability information, airport personnel information, security gate information, ground transportation information, traffic information, and place-of-business information.

In a third aspect, combinable with any of the previous aspects, the user context is a current location of the user, and the best start time is a departure time at which the user is to leave the current location in order to arrive at the airport in time to satisfy the optimizations.

In a fourth aspect, combinable with any of the previous aspects, the user context is a current activity of the user, and the best start time is an activity end time at which the user is to complete or terminate the activity in order to satisfy the optimizations.

In a fifth aspect, combinable with any of the previous aspects, the method further comprises: identifying a promotion associated with one of the resources, the promotion including a reward to the user or identifying a benefit, the promotion designed to entice the user to agree to a start time that further optimizes the multi-human activity scenario; presenting the promotion to the user; receiving, from the user, an acceptance or a non-acceptance of the promotion; and updating the optimizations based on the received acceptance or non-acceptance. In some implementations, after receiving the acceptance or non-acceptance for the user, information can be received indicating user behavior has occurred that indicates that the user has fulfilled conditions of the promotion. The information can be determined, for example, based on the user's current location, based on an action that occurred and was captured electronically (e.g., through the Internet), or based on information provided by the user that states that conditions of the promotion have been met.

In a sixth aspect, combinable with any of the previous aspects, the method further comprises determining that the user acceptance or non-acceptance has not been received in a threshold period of time and updating the optimizations based on non-acceptance.

In a seventh aspect, combinable with any of the previous aspects, the method further comprises: providing notifications to the user at plural times, wherein the notifications include one or more of reminders to the user of an upcoming use of the multi-human activity scenario, one or more suggested or current start times associated with the use, and offers of promotions associated with the resource of the multi-human activity scenario, the promotions being promoted to gain user acceptance of a change to a start time, and wherein the notifications are provided by at least one of website messages, emails, short message service (SMS) messages, phone calls, dedicated application notifications, or push notifications.

In an eighth aspect, combinable with any of the previous aspects, the method further comprises receiving the user preferences through one or more of an app, a sight, a personal identification card, a web page, electronic input, or by voice.

In a ninth aspect, combinable with any of the previous aspects, the user preferences include special requirements.

In a tenth aspect, combinable with any of the previous aspects, the method further comprises training a learning engine, the training using received user preferences and historical information and using information from the learning engine when generating promotions.

In an eleventh aspect, combinable with any of the previous aspects, the user preferences include: time-of-use preferences, including day-of-week and time-of-day preferences; preferred transportation routes; preferred transportation methods; preferred resources; preferred time allocations for additional activities; special needs; and tolerances for waiting in lines and being provided with free time; wherein the user preferences are optionally weighted by the user.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example environment for optimizing and synchronizing people flows.

FIG. 2A is a flowchart of an example method for optimizing and synchronizing people flows.

FIG. 2B is a diagram showing example stations in a multi-station scenario.

FIGS. 2C and 2D show examples of basic queueing system designs.

FIG. 2E shows example characteristics for waiting lines.

FIG. 2F shows example distributions of customer arrival.

FIG. 3 is a block diagram of an exemplary computer system used to provide computational functionalities associated with described algorithms, methods, functions, processes, flows, and procedures as described in the instant disclosure.

### DETAILED DESCRIPTION

This disclosure generally describes computer-implemented methods, software, and systems for optimizing and synchronizing people flows. User preferences associated with a user are received over a computer network. The user preferences include user-desired conditions and constraints of participation by the user in a multi-human activity scenario. A user context associated with the user is received over the computer network. Resource information for resources associated with the multi-human activity scenario is accessed over the computer network. Each resource is to be used by, or available to, the user and the other users during participation in the multi-human activity scenario. An optimized flow of people and formation of optimizations for the multi-human activity scenario are generated by the one or more processors and based on the stored user preferences, the received user context, and the accessed resource information. For example, people flows can be synchronized, balanced and formed that can be used to generate optimizations. The optimizations include a best start time for the user and start times for other users and is generated based on user preferences, current loads of the resources, and expected times of use of the resources by the user and the other users. The optimizations include, for a given resource-user pair, one or more sets of locations, times, and events, each event associated with a separate task of the user at a given resource. A schedule is provided to the user over the computer network. The schedule includes the best start time and, for each resource assigned to the user, a time, a location, and an event schedule indicating mandatory, preferred and optional times and sub-locations of the events. The optimized flow of people and the formation of the optimizations can be used in the forming, managing, optimizing, and synchronizing of people flows in business scenarios.

As an example, the multi-human activity scenario can be an airport, a railway/subway station, a shipment (e.g., involving shippers and recipients), a restaurant, a sports facility, a registration process, a service entity (e.g., automobile repair shop), a health facility, a government facility, a conference, a fair, or some other entity involving one or more people and one or more resources. The user preferences are stored in an electronic database. The optimizations can include users at an airport, and sub-queues can exist, for example, for each of various stations at the airport, such as ticketing, security, boarding and baggage claim, among others. The queues and sub-queues can be used for load balancing, for example, where suggested times for the user's actions are determined and subsequently provided to the user to allow an optimized experience based on the user's defined or interpreted preferences. In another example, the queues and sub-queues can be used for event scenarios (e.g., conferences and fairs).

The subject matter described in this specification can be implemented in particular implementations so as to realize one or more of the following advantages. Businesses and other entities can achieve a more predictable, manageable and efficient use of their resources. Customers and other people can save time and/or avoid unwanted situations by using resources at off-peak times or in a more efficient manner. System information and calculations of various non-connected systems can be integrated and optimized through centralized calculations and considerations. Operators can benefit from resource optimization and improved service reliability, such as reducing delayed flights caused by late passengers. Merchants can realize increased purchasing volumes by providing passengers/customers with more relaxed time between stations. Incoming people flows can be controlled and optimized before the start of a business process, e.g., to evenly spread and balance the load of resources, to prevent traffic jams, long lines and wasted time, and to maximize resource use of the business process. Traffic jams and gate delays can be predicted and prevented. Business sales can increase. User errors and conflicts can be avoided, which can provide a better user experience.

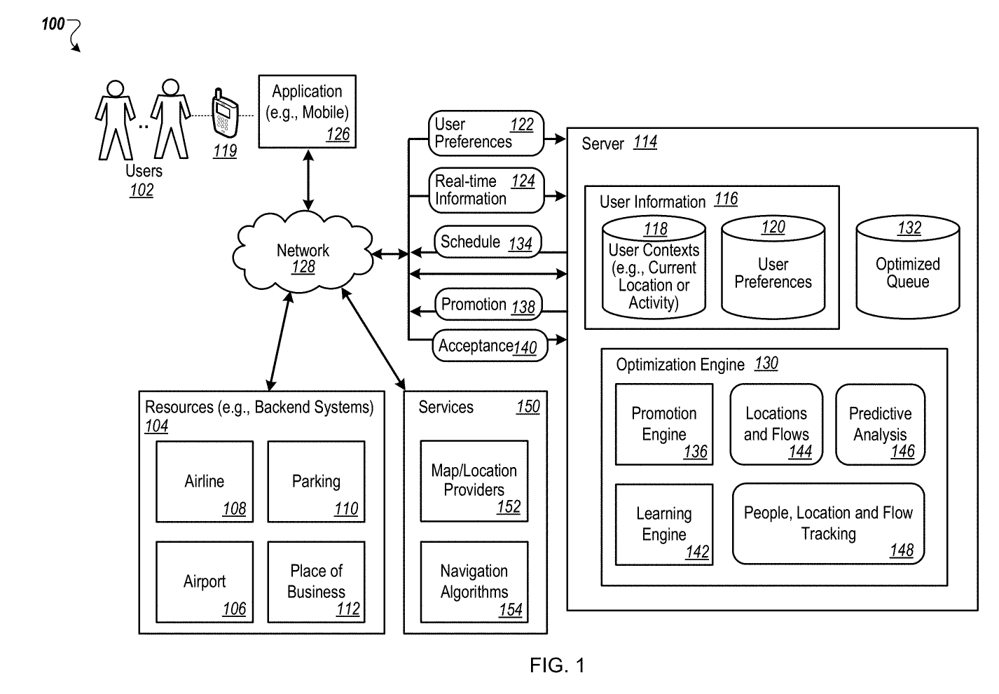

FIG. 1 is a block diagram of an example environment 100 for optimizing and synchronizing people flows. For example, the environment 100 can be used by users 102, such as end users who plan to use one or more resources 104. A multi-human activity scenario involving the resources 104, for example, can include use of an airport 106, one or more airlines 108, parking facilities 110, and places of business 112 (e.g., restaurants and stores, such as duty-free shops). Other resources 104 are possible, such as the resources listed above, including but not limited to railway/subway stations, shipments, restaurant, sports facilities, registration processes, service entities, health facilities, and government facilities.

A server 114 can include and/or initiate components that perform the optimization and synchronization of the people flows. For example, the server 114 can include (or access) user information 116 associated with the users 102. The user information 116 includes user contexts 118 and user preferences 120, but other user information is possible. User contexts 118, for example, can define a current location or a current activity of each of the users 102. User preferences 120, for example, can define user-desired conditions and constraints of participation by the user 102 in a multi-human activity scenario. User preferences can include, for example, time-of-use preferences, including day-of-week and time-of-day preferences, preferred transportation routes, preferred transportation methods, preferred resources, preferred time allocations for additional activities (e.g., shopping or spending time in a coffee shop), special needs of the user, and user tolerances for waiting in lines and/or being provided with free time. Tolerances, for example, can include tolerances for arriving at times that are earlier versus later than preferred (e.g., leading to additional free time versus no time for shopping). User information 116 for a user can include, for example, the user's location at the start of the trip, the user's nationality (e.g., if provided voluntarily by the user and used in countries' processes that vary for different nationalities), the user's general health condition (e.g., motoric, sensorial, or other conditions), user language barriers (e.g., that may require additional personnel and/or time), the user's trip destination, and the user's age. In general, determining optimization and synchronization of people flows can depend on the user's profile, a user's activity profile and trip whereabouts, the user's current health state, and historical choices regarding promotions previously made by the user. User preferences can also include or be used to identify a willingness of the user to be offered rewards, e.g., in return for arriving at a different time. In some implementations, user preferences can be derived or generated using learning systems, e.g., by analyzing user habits. In some implementations, user information 116 can be populated and maintained based on user preferences 122 and real-time information 124 received from the users 102. Real-time information 124 can include information received from various sources that may impact optimization, not only of the users, but of the resources 104. For example, the real-time information 124 can include real-time traffic condition feeds and real-time occupation in a target service, such as the number of people presently at an airport or the number of beds or other hospital resources that are currently occupied.

In some implementations, the user information 116 received can be based on user 102 inputs made through an application 126, such as a mobile app, and information associated with a user can be received from other sources over a network 128. In some implementations, the network 128 can include the Internet, a local area network (LAN), a wide area network (WAN), a wireless network, or any combination of these and other networks. In still other instances, user information 116 can be generated based on monitored user activities as permitted by the user. For example, historical information from prior activities may be used to identify and store user preferences based on monitored repetitions of a particular order of activity (e.g., actions taken when at an airport, including arrival time, route traveled, actions taken while at the airport, etc.), an average arrival time prior to scheduled events (e.g., different events may be associated with different arrival times, including flights, trains, appointments, meetings, etc.), and other monitored activities.

The server 114 can include an optimization engine 130 that can generate an optimized queue 132. In order to obtain information needed to generate an optimized queue 132, the optimization engine 130 can access, e.g., over the network 128, resource information for the resources 104 that are associated with the multi-human activity scenario such as an airport. In this example, the optimized queue 132 to be generated can be a queue associated with the users 102 who are planning to use an airport. For example, each of the resources 104 may be used by, or available to, the users 102 during participation in the multi-human activity scenario, such as using the airport. Generation of the optimized queue 132 can be based on the stored user preferences 120, a received user context (e.g., included in real-time information 124), and the accessed resource information. A goal of the optimized queue 132 can be to balance flows of people and unstructured queues in order, for example, to form optimized queues. The optimized queues can be used, for example, to create a master schedule that incorporates individual user-specific schedules, each user-specific schedule for a particular user being based on the user preferences and received context for the particular user. Further, the optimized queue 132 can be based on current and projected loads on the resources 104 to be used by the users 102. For each of the users 102 associated with the airport, for example, the optimized queue 132 can define a schedule for each user, include a start time for a particular user 102 and start times for other users 102. The optimized queue 132 can be generated based on current loads of the resources 104 and expected times of use of the resources 104 by the users. The optimized queue 132 can actually be a data store of one or more optimized queues, each of which can be a stand-alone optimized queue or related in some way to other optimized queues. Although referred to herein as an “optimized queue,” the optimized queue 132 generated at 210 may instead or alternatively be considered an “optimized queue goal” or a “target state,” as the queue does not manifest in real life unless and until the user(s) obey or follow the instructions/suggestions.

The optimized queue 132 can include, for a given resource-user pair, one or more sets of locations, times, and events. The optimized queue 132 can represent and/or include a sequence or collection of tasks to be performed. For example, each event can be associated with a separate task or activity of the user at or associated with a given resource, such as a station at an airport, or a different department or room visited by a patient at a health facility. Some resources can be location-based, such as having an associated address, building, room number, or other location, and some resources can be location-independent, such as a boarding pass that is generated online or through an app.

Using information from the optimized queue 132 (that is associated with multiple users 102), the server 114 can provide a schedule 134 to the user 102 that includes the best start time (e.g., a time to leave home) associated with the schedule. Further, the schedule can include, for each resource assigned to the user, a time, a location, and an event schedule indicating mandatory, preferred, and/or optional times, and sub-locations of the events. Locations can include, for example, addresses, room numbers, building/department names, web site addresses (e.g., for a schedule of tasks that the user 102 is to perform online), or some combination of above. In some implementations, the schedule 134 can include, or be generated from, predecessor/successor information associated with steps that the user 102 is to perform (e.g., check in at the ticketing counter before proceeding to security). Each schedule 134 can be provided in electronic form (e.g., displayable in the application 126), provided in hard-copy form, or available in other ways. In some instances, tasks and activities need not be dependent on one another (e.g., physically, temporally, or sequentially), and a user 102 can be sent simply to the most available activity without a required correspondence or sequence to other activities.

The optimization engine 130 can include plural engines and/or other inputs. For example, a promotion engine 136 can generate promotions 138 that are offered to the user 102. Each promotion, for example, can have the goal to affect and/or improve the optimized queue 132. For example, a promotion can be identified that is associated with one of the resources 104 (e.g., airport security), such as to entice the user 102 to use the resource 104 at an off-peak (or to balance some other load, such as staffing). The promotion can include a reward offered to the user 102, such as for agreeing to a start time, e.g., to entice the user 102 to leave for the airport at an earlier or later time than would normally be the case. After the promotion 138 is presented to the user, an acceptance 140 or a non-acceptance of the promotion can be received from the user 102. Acceptance of a promotion can occur based on the user's explicit action, such as clicking on an acceptance control/button, or by other actions of the user. The server 114 can offer several of the users 102 one or more different promotions 138, such as to try to distribute airport arrival times for several passengers across time in order to improve efficiency of handling large numbers of people. In some implementations, a particular promotion may be offered (or not offered) to the user 102 based on the user's previous history of accepting (or not accepting) a promotion of a similar type. In some implementations, a reward associated with a promotion 138 can include one or more of a monetary reward, a reduced rate or fee, a coupon, an upgrade, points associated with a reward program, or some other incentive.

A learning engine 142, for example, can be trained over time based on received user preferences 120 and historical information such as past promotions 138 either accepted or not accepted by the user and/or automatically by the user profile. Information provided by the learning engine 142 can be used, for example, when generating promotions 138. In some implementations, information from the learning engine 142 can be used to generate the optimized queue 132, such as to account for past user actions (e.g., arriving late to the airport) that can affect an accuracy or a probability of success of the optimized queue 132 (e.g., measured by how well resources 104 were subsequently optimized). In some implementations, the learning engine 142 can use information associated with a history of other users that have matching profiles/preferences as well as matching conditions not necessarily of the user/resources at a current time.

The optimization engine 130 can use algorithms and or other types of processing to use and/or incorporate various concepts, e.g., locations and flows 144, predictive analysis 146, and people, location and flow tracking 148. For example, at any given time, the optimized queue 132 can include real-time changes based on received real-time information 124, acceptance 140 of promotions 138, user contexts 118, and user preferences 120.

In some implementations, the environment 100 can include the use of service 150, such as map/location providers 152 and navigation algorithms 154. Other services 130 are possible, such as associated with weather, traffic, and current events, and some services may be resident in the optimization engine 130, the application 126, or provided by the resources 104. The optimization engine 130 can use the services 150, for example, to determine travel times and routes, such as based on a user's current or planned location. The services 150, if implemented in (or accessible from) the application 126, can be used to provide maps to users that may be associated with (e.g., integrated within or accessed by) the schedule 134 provided to the user 102. Map/location providers 152 can provide maps and/or other information associated with indoor locations, outdoor locations, or some combination thereof.

In some implementations, the optimization engine 130 can merge unrelated queues, such as to optimize the use of resources 104 for different groups of people. For example, multiple schedules of different users 102 from different optimized queues 132 may all use the same resource 104 and/or the same parking facility 110, and planned use by some users 102 may affect the available capacity of use by others. In order to create one or more optimized queues 132 in this type of situation, the promotion engine 136 can generate promotions 138 in order to entice users 102 to use a different parking facility 110, arrive at a different time, or to make other plans.

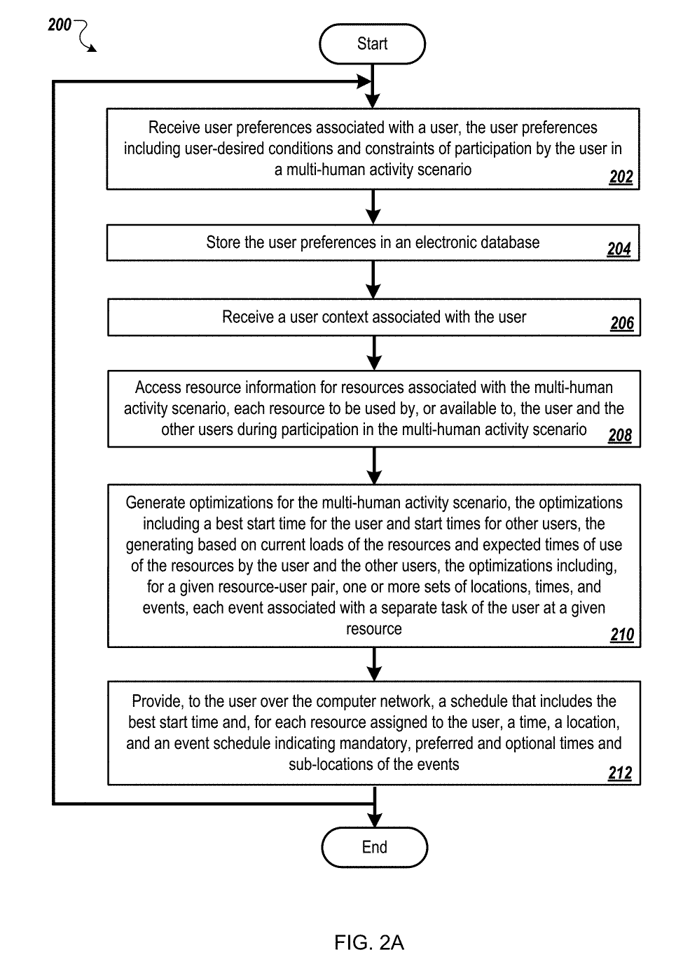

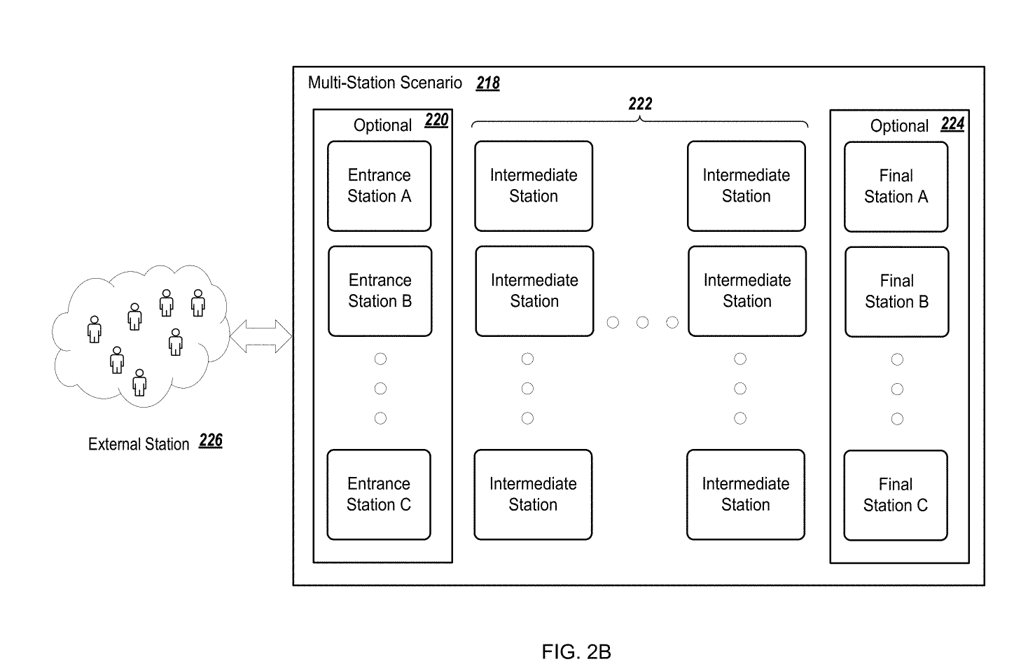

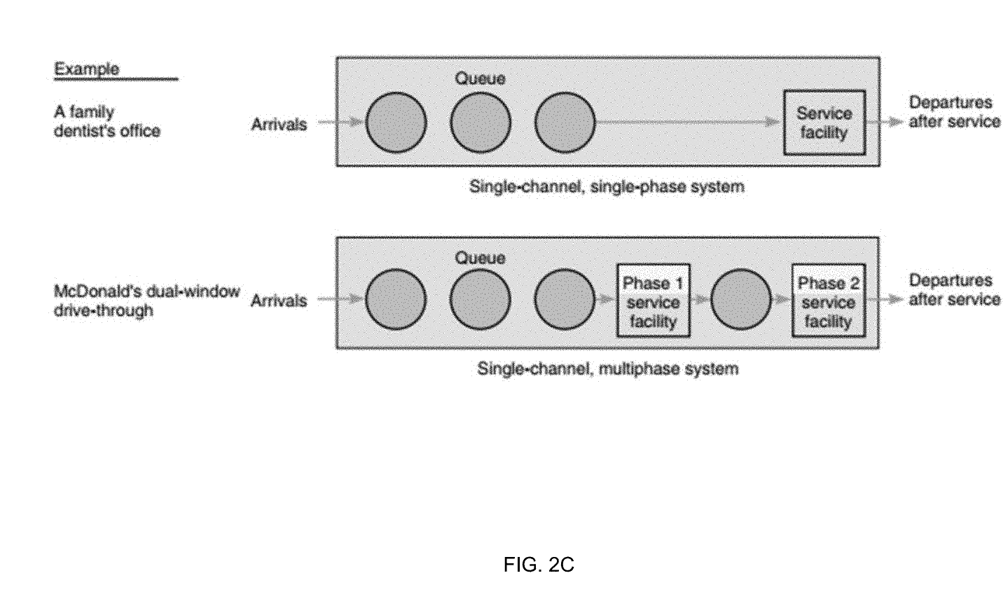

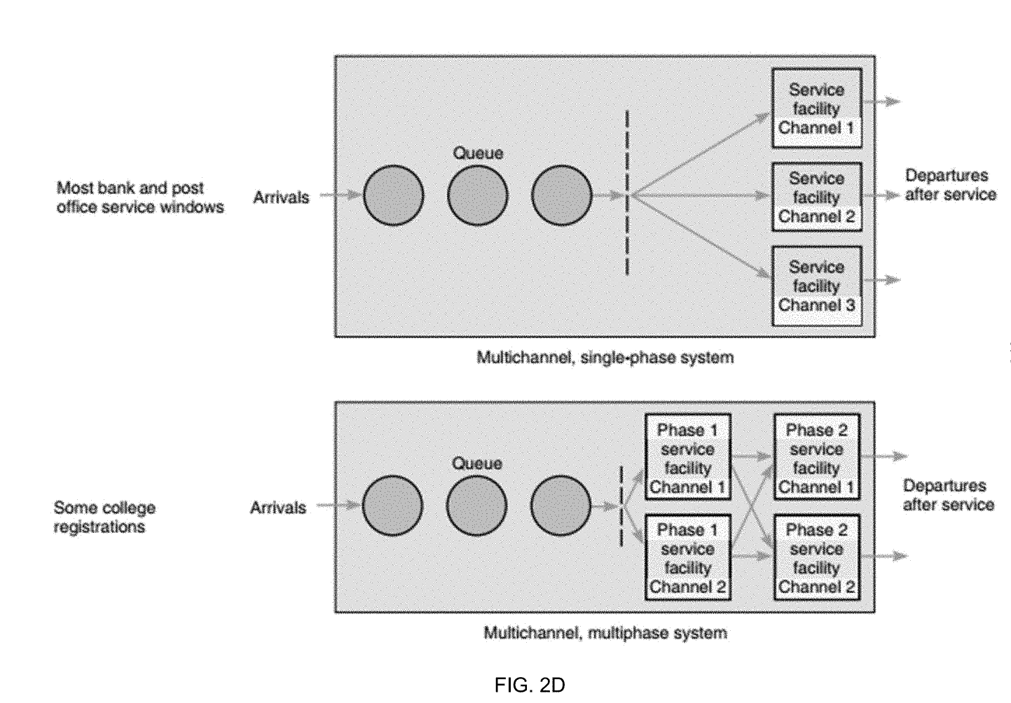

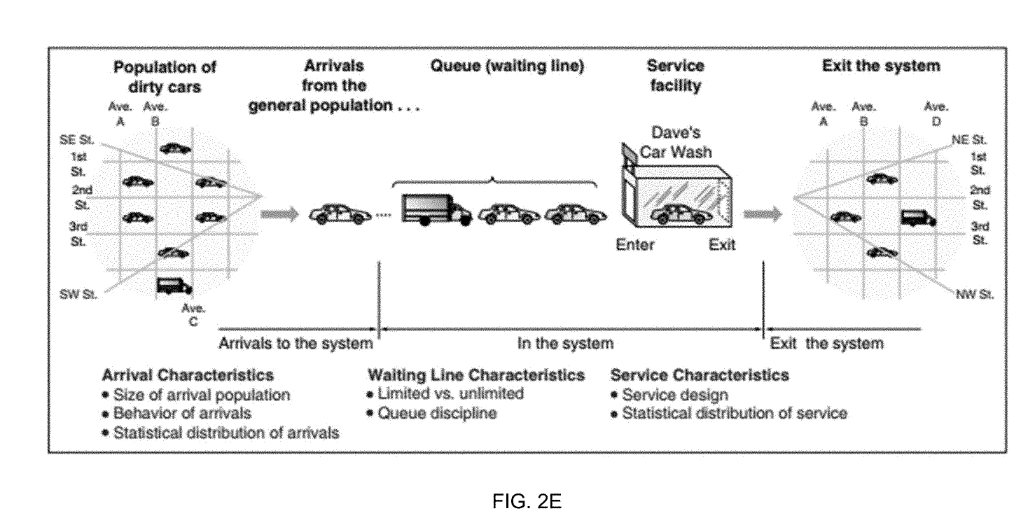

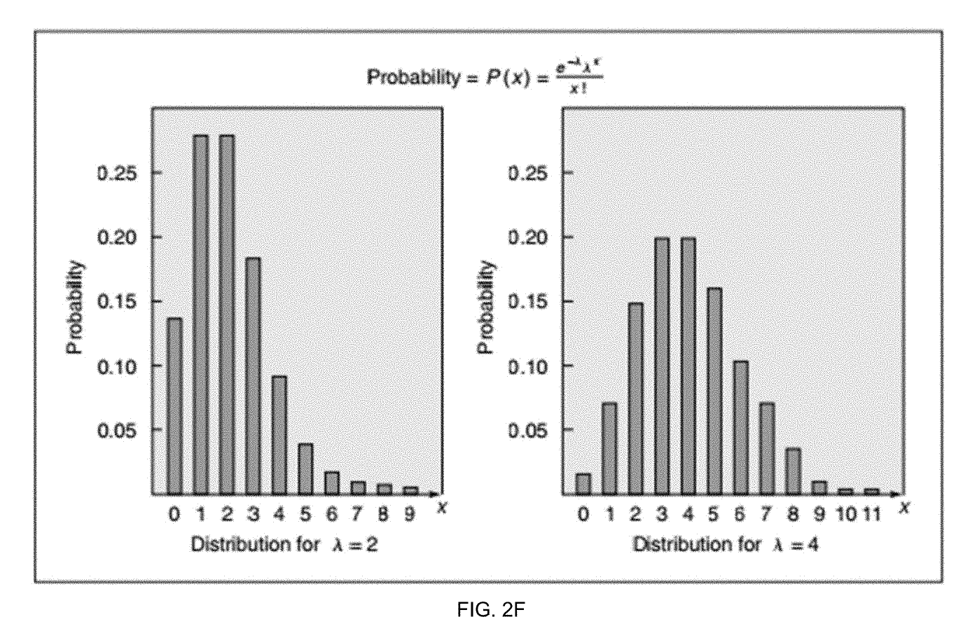

FIG. 2A is a flowchart of an example method 200 for optimizing and synchronizing people flows. For clarity of presentation, the description that follows generally describes method 200 in the context of FIG. 1.

At 202, user preferences associated with a user are received over a computer network. The user preferences include user-desired conditions and constraints of participation by the user in a multi-human activity scenario. For example, the user preferences can be received through one or more of an app, a web page/site, a personal identification card, or by voice. For example, the server 114 can receive the user preferences 122 that are associated with the user 102.

User preferences can include any of the following. Time-of-use preferences, including day-of-week and time-of-day preferences, for example, can identify hours of the day and/or days of the week that the user prefers to use a resource 104. Examples include preferred airline flight days and times, preferred days of the week, times for medical appointments, black-out days/times (e.g., for which scheduling for the user is not to occur), and special dates (e.g., birthdays, anniversaries, vacations). Preferred transportation routes, for example, can include countries, states, cities, and/or routes (e.g., highways, or types of highways) to avoid. Preferred transportation methods can include, for example, preferences for certain types of travel, such as airline, train/rail, bus, subway, automobile/taxi. Preferred resources, for example, can include user preferences (or dislikes for) certain airports, airline carriers, restaurants, and hospitals/clinics. Preferred time allocations for additional activities, for example, can be used by the user to identify a preference for inclusion of additional time for shopping, stopping for coffee, grabbing a meal, making a call, visiting a specific place, or taking a rest. Special needs, for example, can include information such as a size of a family or other party, the presence of children and/or elderly (e.g., who may need more time for boarding a plane), nationality/security issues, language preferences, or the presence of pets. Preferences associated with tolerances for waiting in lines and being provided with free time, for example, can indicate that the user dislikes (or rather tolerates) long lines and/or other conveniences. For example, information associated with free time preferences of the user can be used to schedule the user for an earlier arrival at the airport, such as to avoid heavy traffic, providing the user is prepared to wait at a gate and perhaps read a book or magazine.

In some implementations, the user preferences can include special requirements, such as diet restrictions of the user, information about special needs (e.g., disabilities, restrictions) of the user or people (e.g., family members) in the user's group. User preferences can also be used to identify users that may need longer security checks (e.g., based on nationality issues related to travel destinations) and users that have language barriers.

In some implementations, the user preferences can be optionally weighted by the user. For example, when defining user preferences, the user can indicate which preferences are more important than others, e.g., using a ranking, a weight or score, or in some other way. In some implementations, user preferences can be defined with relationships, for example, along the lines of “I don't mind arriving significantly early to the airport or flying with Carrier Y if this will save me at least $X or cost me M minutes.” Other user preferences can include, for example, avoiding flights that have layovers, avoiding certain airports, avoiding layovers that risk missing connecting flights, and other preferences.

At 204, the user preferences are stored in an electronic database. For example, user preferences 120 can be stored at the server 114 and updated over time by the users 102.

At 206, a user context associated with the user is received over the computer network. For example, the user context can be included in real-time information 124 and can include a current location of the user. Current activities of the user can include, for example, a location at home, work, school, a place-of-business, or on the road. In some implementations, current locations can be determined automatically such as through global positioning system (GPS) capabilities of the user's mobile. In some implementations, current locations can be provided by the user and can include, for example, a current street address, a current longitude/longitude, an Internet Protocol (IP) address associated with a known location, a location determined from communication towers, or a general location or distance from a resource (e.g., “I am ten minutes from the airport.”). In some implementations, the user context can be a current activity of the user, and the best start time can be an activity end time at which the user is to complete or terminate the activity in order to satisfy the optimizations. Current activities of the user can include, for example, packing for a trip, completing reservations, enjoying a meal, participating in a meeting, driving, and waiting for ground transportation.

At 208, resource information for resources associated with the multi-human activity scenario are accessed over the computer network. For example, each resource 104 can be used by, or available to, the user 102 and other users during participation in the multi-human activity scenario.

At 210, optimizations for the multi-human activity scenario are generated by one or more processors. For example, generation of the optimized queue 132 can be based on the stored user preferences 120, the received user context (e.g., through real-time information 124, and the accessed resource information (e.g., associated with resources 104). The optimized queue 132 can include a best start time for the user 102 and start times for other users 102. The optimized queue 132 can be generated based on current loads of the resources and expected times of use of the resources by the user and the other users. The optimized queue 132 can include, for a given resource-user pair, one or more sets of locations, times, and events, and each event can be associated with a separate task of the user at a given resource. The optimized queue 132 can include and/or identify one or more sets of locations, times, events, and user rewards and/or other incentives, e.g., to reward the user to arrive at a given proposed time or perform some other action at a particular time.

At 212, a schedule is provided to the user. For example, the schedule 134 can be provided over the network 128 and can include the best start time and, for each resource assigned to the user 102, a time, a location, and an event schedule indicating mandatory, preferred and optional times and sub-locations of the events. In some implementations, the schedule can be provided as a combinations of one or more of a link, a web page, an email, an app on a mobile device, a notification, and a hard-copy print-out (e.g., from an airport kiosk), and the schedule 134 can include one or more maps associated with the schedule.

In some implementations, the method 200 can further include receiving information associated with one or more of resource availability, staffing conditions of the resources, weather conditions associated with the multi-human activity scenario, traffic conditions for routes near or associated with the multi-human activity scenario, and a health condition of the user. Further, generating the optimizations can include evaluating the information, including historical information, recent conditions, current conditions, and predicted conditions. For example, the multi-human activity scenario can be an airport, and the best start time can be a time at which the user is to leave home or another location for the airport. The resources, for example, can include an airport facility, airline carriers using the airport facility, security gates at the airport facility, parking facilities, ground transportation, highways, and places of business (e.g., restaurants and stores, such as duty-free shops). Generating the optimizations can then further include evaluating applicable ones of airline schedules, estimated airline arrivals and departures, parking availability information, airport personnel information, security gate information, ground transportation information, traffic information, and place-of-business information. In some implementations, the best start time can be more significant in terms of optimization, e.g., once a business scenario has started, other points along the way can tend to be less influential.

In some implementations, resource availability can include information regarding a current state of machinery, such as whether the machinery is currently functioning versus malfunctioning or suffering from a broken part. In some implementations, resources 104 can have temporary access limitations, e.g., so not all components are available to one or more users 102 (e.g., if an elevator/escalator is broken) or running at a reduced capacity, requiring wait times for users. In some implementations, resources can have technical limitations, such as load capacities, e.g., if a room or area can only accommodate N people at one time. Resource availability can also include information about security limitations, limited public transport (e.g. if a labor strike is effective), and/or internal limitation (e.g., airport transport limitations during rush hour when fewer inter-terminal minibuses are available).

In some implementations, the method 200 can further include using promotions offered to the user, and optionally accepted to the user, to affect and/or improve the optimizations, using the following. For example, a promotion 138 can be identified that is associated with one of the resources 104, such as to entice the user 102 to use the resource 104 (e.g., airport security) at a less busy time. The promotion 138 can include a reward offered to the user for agreeing to a start time that further optimizes the multi-human activity scenario (e.g., the optimized queue 132). After the promotion 138 is presented to the user, an acceptance 140 or a non-acceptance of the promotion can be received from the user. The optimized queue 132 can be updated, for example, based on the received acceptance or non-acceptance. In some implementations, the method 200 can further include determining that the user acceptance or non-acceptance has not been received in a threshold period of time, and the optimized queue 132 can be updated based on non-acceptance.

In some implementations, notifications can be provided to the user at plural times, such as one or more days or weeks before the best start time, hours before the best start time, and/or at other times. The notifications can include, for example, one or more reminders to the user of an upcoming use of the multi-human activity scenario (e.g., referencing or including some or all of the schedule provided to the user), one or more suggested or current start times associated with the use, and offers of promotions associated with the resource of the multi-human activity scenario, the promotions being promoted to gain user acceptance of a change to a start time. The notifications can be provided in one or more of various ways, such as using website messages, emails, SMS messages, phone calls, dedicated application notifications, or push notifications. In some implementations, users can establish and maintain notification preferences associated with notifications. In some implementations, notifications can be sent that query the user 102 as to the user's progress or likelihood to be on time, early or late, to which the user 102 can provide a response, information from which can be used to update the optimized queue 132.

In some implementations, the method 200 can further include training a learning engine. For example, the learning engine 142 can be trained based on received user preferences 120 and historical information such as past promotions 138 either accepted or not accepted by user and other users (and further based on acceptances that were chosen and implemented by the optimization engine 130), and information from the learning engine 142 can be used when generating promotions 138. Using the learning engine 142 can improve the generation of the optimized queue 132, such as by evaluating past loads in queues (e.g., at airport security), expected users (e.g., passengers), and promotions that are likely to be accepted. Use of the learning engine, for example, can lead to reductions in total cost of ownership (TCO).

FIG. 2B is a diagram showing example stations in a multi-station scenario 218. In the multi-station scenario 218, for example, people are expected to go through different stations where the following characteristics apply. A station can be, for example, a place where queues are not relevant. For example, the station can be a waiting area for a single mean of internal transportation (e.g., shuttle, elevator), or a station can be a public gathering area (e.g., deck, duty-free zone, etc.). A station can also be a place where people are lining up (e.g., boarding, customs) where queues may be formed. There may optionally be one or more entrance stations 220 where a person can begin the process. There can be any number of intermediate stations 222. There may optionally be one of more final stations 224 where a person may end the process. An exterior world can include external stations 226 that may be other stations in the process (e.g., the system may suggest, due to overbooking, to leave, and show up in a different time). The scenario may optionally dictate an order between some or all the stations. The scenario may optionally dictate priority between some or all the stations (e.g., duty-free is not a mandatory station in the process of onboarding). In FIG. 2B, note that there are no arrows that dictate flows, as any configuration can exist.

Optimization strategies can exist for the multi-station scenario 220. For example, when a service is characterized as a multi-station scenario, several aspects may be targeted for optimization. Targeting can include, for example, increasing service provider profit by one or more of reducing required personnel, equipment, or space; reducing energy, water, or gas consumption; and reducing operational faults (e.g., reducing missed flights). Targeting can also include, for example, increasing user satisfaction, e.g., by reducing crowded areas, reducing waiting times, increasing rest times, and meeting standards such as company standards, legal standards, or International Organization for Standardization (ISO) standards.

A primary focus of the methods, software, and systems described by this disclosure is achieving optimization by all relevant available data, in order to calculate not only a real-time optimization, but also recommendations of how to alter the status, by encouraging customers to change their plans, based on their profiles and providing for them rewards for their behavior change. For example, the optimization engine 130 can select and apply algorithms according to the relevant service system structure and characteristics, as well as the target optimization.

Optimization of the above aspects can result in different types of outputs and may require different types of calculations/algorithms to be applied, all depending on the service provider target at a given time. For example, in order to reduce TCO, a person may be directed in a route that will force a less optimal queue at a given station, hence resulting in a less optimal flow. In order to meet safety standards, for example, a person may be directed to go through the required stations in a less optimal order. In order to increase customer satisfaction, for example, station queue management may be less efficient (e.g., to increase privacy)

Traditional queue optimization is a technique that can be applied as part of an overall optimization in order to optimize a certain station (e.g., relative to waiting lines), or a flow between several stations (e.g., relative to multiple waiting lines). This queue optimization can be achieved by an engine that can process the queue characteristics and real-time input, calculate a recommended arrival flow (e.g., a Poisson distribution characteristic of the queue), and output a list of customers that the system should encourage to alter their arrival times to the given station. The methods, software, and systems described by this disclosure can assume that an applied optimization engine is a black box and that the applied algorithms are transparent.

Different queue (e.g., multiple waiting line) optimization and algorithms can be used. For example, optimization associated with waiting line and queue management can deal with issues associated with the treatment of customers, e.g., to reduce wait times, improve service, and improve TCO. Service systems can be characterized by a wide verity of queuing models, such as single-channel queuing models (e.g., with Poisson arrivals and exponential service times), multiple-channel queuing models, constant-service-time models, and limited-population models.

FIGS. 2C and 2D show examples of basic queueing system designs. Examples of real-world queueing systems can include the following. Commercial queueing systems can include commercial organizations that serve external customers, such as dentists, banks, automated teller machines, gas stations, plumbers, and garages. Transportation service systems can include, for example, vehicles (e.g., that are customers or servers), such as a vehicle waiting at a toll station or a traffic light, trucks or ships waiting to be loaded/unloaded, taxi cabs, fire engines, elevators, and buses. Business-internal service systems can serve customers receiving service that is internal to the organization providing the service, e.g., inspection stations, conveyor belts, and computer support. Social service systems can include, for example, the services of the judicial process, emergency rooms at hospitals, waiting lists for organ transplants, and student dorm rooms.

Queuing analysis can result in many measures of a waiting-line system's optimizations, including, for example, an average time that each customer or object spends in the queue, an average queue length, an average time that each customer spends in the system (e.g., waiting time plus service time), an average number of customers in the system, a probability that the service facility will be idle, a utilization factor for a system, and a probability of a specific number of customers in the system. The applied algorithms outputs, for example, can enable optimization of one or many of the above aspects.

FIG. 2E shows example characteristics for waiting lines. In some implementations, different waiting line characteristics can influence the type of output algorithms that are expected to produce for optimization purposes. A population characteristic, for example, may be infinite or finite (e.g., for fixed-time or limited customers). In case of an infinite scenario, for example, algorithms can be applied in order to narrow or reduce population scenarios to sets of finite timeslots (e.g., for an X amount of customers). For an arrival waiting line characteristic, for example, different characteristics can exist. For example, customer arrival can be by single customer, a batch of customers, or a bulk of customers.

FIG. 2F shows example distributions of customer arrival. In some implementations, arrival distributions over time can be “memoryless” (e.g., a Poisson distribution, with an average arrival rate), a predicted distribution, a random distribution, or some other distribution. In a Poisson distribution, for example, one of the potential algorithms' outcomes can indicate, for example, that be the amount of arrivals are to be shifted, such as to raise the probability to a predicted distribution (e.g., unified, but not necessarily so), or in order to balance and further optimize the flow in the system. Outcomes can further be used as inputs for the optimization engine 130, e.g., to encourage different passengers to arrive in desired times.

Service configuration is another type of waiting line characteristic. For example, service configurations can be single channel, single phase (e.g., ship yards and car wash facilities); single channel, multi-phase (e.g., bank tellers); multi-channel, single phase (e.g., separate queue of man and women for single ticket window); multi-channel, multi-phase (e.g., laundromats that have options of several washers and several dryers); and multiple waiting lines or stations (e.g., airport onboarding). In the case of the multiple waiting lines, for example, algorithms outcomes can include reordering of the stations.

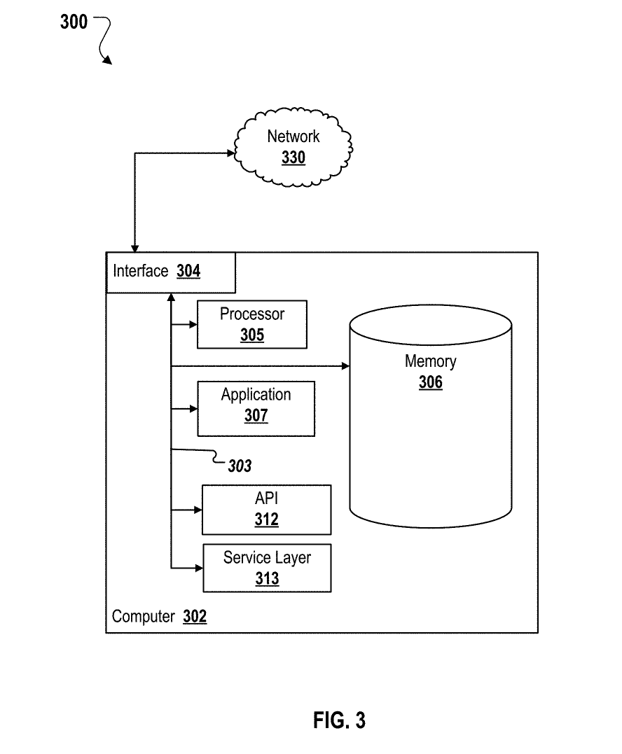

FIG. 3 is a block diagram of an exemplary computer system 300 used to provide computational functionalities associated with described algorithms, methods, functions, processes, flows, and procedures as described in the instant disclosure.

The illustrated computer 302 is intended to encompass any computing device such as a server, desktop computer, laptop/notebook computer, wireless data port, smart phone, personal data assistant (PDA), tablet computing device, wearable device, one or more processors within these devices, or any other suitable processing device, including both physical or virtual instances (or both) of the computing device. Additionally, the computer 302 may comprise a computer that includes an input device, such as a keypad, keyboard, touch screen, or other device that can accept user information, and an output device that conveys information associated with the operation of the computer 302, including digital data, visual, or audio information (or a combination of information), or a GUI.

The computer 302 can serve in a role as a client, network component, a server, a database or other persistency, or any other component (or a combination of roles) of a computer system for performing the subject matter described in the instant disclosure. The illustrated computer 302 is communicably coupled with a network 330. In some implementations, one or more components of the computer 302 may be configured to operate within environments, including cloud-computing-based, local, global, or other environment (or a combination of environments).

At a high level, the computer 302 is an electronic computing device operable to receive, transmit, process, store, or manage data and information associated with the described subject matter. According to some implementations, the computer 302 may also include or be communicably coupled with an application server, e-mail server, web server, caching server, streaming data server, business intelligence (BI) server, or other server (or a combination of servers).

The computer 302 can receive requests over network 330 from a client application (for example, executing on another computer 302) and responding to the received requests by processing the said requests in an appropriate software application. In addition, requests may also be sent to the computer 302 from internal users (for example, from a command console or by other appropriate access method), external or third-parties, other automated applications, as well as any other appropriate entities, individuals, systems, or computers.

Each of the components of the computer 302 can communicate using a system bus 303. In some implementations, any or all of the components of the computer 302, both hardware or software (or a combination of hardware and software), may interface with each other or the interface 304 (or a combination of both) over the system bus 303 using an application programming interface (API) 312 or a service layer 313 (or a combination of the API 312 and service layer 313). The API 312 may include specifications for routines, data structures, and object classes. The API 312 may be either computer-language independent or dependent and refer to a complete interface, a single function, or even a set of APIs. The service layer 313 provides software services to the computer 302 or other components (whether or not illustrated) that are communicably coupled to the computer 302. The functionality of the computer 302 may be accessible for all service consumers using this service layer. Software services, such as those provided by the service layer 313, provide reusable, defined business functionalities through a defined interface. For example, the interface may be software written in JAVA, C++, or other suitable language providing data in extensible markup language (XML) format or other suitable format. While illustrated as an integrated component of the computer 302, alternative implementations may illustrate the API 312 or the service layer 313 as stand-alone components in relation to other components of the computer 302 or other components (whether or not illustrated) that are communicably coupled to the computer 302. Moreover, any or all parts of the API 312 or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302. The interface 304 is used by the computer 302 for communicating with other systems in a distributed environment that are connected to the network 330 (whether illustrated or not). Generally, the interface 304 comprises logic encoded in software or hardware (or a combination of software and hardware) and operable to communicate with the network 330. More specifically, the interface 304 may comprise software supporting one or more communication protocols associated with communications such that the network 330 or interface's hardware is operable to communicate physical signals within and outside of the illustrated computer 302.

The computer 302 includes a processor 305. Although illustrated as a single processor 305 in FIG. 3, two or more processors may be used according to particular needs, desires, or particular implementations of the computer 302. Generally, the processor 305 executes instructions and manipulates data to perform the operations of the computer 302 and any algorithms, methods, functions, processes, flows, and procedures as described in the instant disclosure.

The computer 302 also includes a memory 306 that holds data for the computer 302 or other components (or a combination of both) that can be connected to the network 330 (whether illustrated or not). For example, memory 306 can be a database storing data consistent with this disclosure. Although illustrated as a single memory 306 in FIG. 3, two or more memories may be used according to particular needs, desires, or particular implementations of the computer 302 and the described functionality. While memory 306 is illustrated as an integral component of the computer 302, in alternative implementations, memory 306 can be external to the computer 302.

The application 307 is an algorithmic software engine providing functionality according to particular needs, desires, or particular implementations of the computer 302, particularly with respect to functionality described in this disclosure. For example, application 307 can serve as one or more components, modules, applications, etc. Further, although illustrated as a single application 307, the application 307 may be implemented as multiple applications 307 on the computer 302. In addition, although illustrated as integral to the computer 302, in alternative implementations, the application 307 can be external to the computer 302.

There may be any number of computers 302 associated with, or external to, a computer system containing computer 302, each computer 302 communicating over network 330. Further, the term “client,” “user,” and other appropriate terminology may be used interchangeably as appropriate without departing from the scope of this disclosure. Moreover, this disclosure contemplates that many users may use one computer 302, or that one user may use multiple computers 302.

In some implementations, components of the environments and systems described above may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, components may be adapted to execute any operating system, including Linux, UNIX, Windows, Mac OS®, Java™, Android™, iOS or any other suitable operating system. According to some implementations, components may also include, or be communicably coupled with, an e-mail server, a web server, a caching server, a streaming data server, and/or other suitable server(s).

Processors used in the environments and systems described above may be a central processing unit (CPU), an application specific integrated circuit (ASIC), a field-programmable gate array (FPGA), or another suitable component. Generally, each processor can execute instructions and manipulates data to perform the operations of various components. Specifically, each processor can execute the functionality required to send requests and/or data to components of the environment and to receive data from the components of the environment, such as in communication between the external, intermediary and target devices.

Components, environments and systems described above may include a memory or multiple memories. Memory may include any type of memory or database module and may take the form of volatile and/or non-volatile memory including, without limitation, magnetic media, optical media, random access memory (RAM), read-only memory (ROM), removable media, or any other suitable local or remote memory component. The memory may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, for references thereto associated with the purposes of the target, intermediary and external devices. Other components within the memory are possible.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Peri®, any suitable version of 4GL, as well as others. Software may instead include a number of sub-modules, third-party services, components, libraries, and such, as appropriate. Conversely, the features and functionality of various components can be combined into single components as appropriate.

Devices can encompass any computing device such as a smart phone, tablet computing device, PDA, desktop computer, laptop/notebook computer, wireless data port, one or more processors within these devices, or any other suitable processing device. For example, a device may comprise a computer that includes an input device, such as a keypad, touch screen, or other device that can accept user information, and an output device that conveys information associated with components of the environments and systems described above, including digital data, visual information, or a graphical user interface (GUI). The GUI interfaces with at least a portion of the environments and systems described above for any suitable purpose, including generating a visual representation of a web browser.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although this disclosure has been described in terms of certain implementations and generally associated methods, alterations and permutations of these implementations, and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving, over a computer network, user preferences associated with a user, wherein the user preferences include user-desired conditions and constraints of participation by the user in a multi-human activity scenario;
storing the user preferences in an electronic database;
receiving, over the computer network, a user context associated with the user;
accessing, by one or more processors, resource information for resources associated with the multi-human activity scenario, each resource to be used by, or available to, the user and the other users during participation in the multi-human activity scenario;
generating, by the one or more processors and based on the stored user preferences, the received user context, and the accessed resource information, optimizations for the multi-human activity scenario, the optimizations including a best start time for the user and best start times for other users, wherein the optimizations are generated based on current loads of the resources and expected times of use of the resources by the user and the other users, wherein the optimizations include, for a given resource-user pair, one or more sets of locations, times, and events, each event associated with a separate task of the user at a given resource; and
providing, to the user over the computer network, a schedule that includes the best start time and, for each resource assigned to the user, a time, a location, and an event schedule indicating mandatory, preferred and optional times and sub-locations of the events.

2. The computer-implemented method of claim 1, further comprising:
receiving information associated with one or more of resource availability, staffing conditions of the resources, weather conditions associated with the multi-human activity scenario, traffic conditions for routes near or associated with the multi-human activity scenario, and a health condition of the user; and
wherein generating the optimizations includes evaluating the information, including historical information, recent conditions, current conditions, and predicted conditions.

3. The computer-implemented method of claim 2, wherein the multi-human activity scenario is an airport;
wherein the best start time is a time at which the user is to leave for the airport;
wherein the resources include an airport facility, airline carriers using the airport facility, security gates at the airport facility, parking facilities, ground transportation, highways, and businesses; and
wherein generating the optimizations further includes evaluating applicable ones of airline schedules, estimated airline arrivals and departures, parking availability information, airport personnel information, security gate information, ground transportation information, traffic information, and place-of-business information.

4. The computer-implemented method of claim 3, wherein the user context is a current location of the user, and wherein the best start time is a departure time at which the user is to leave the current location in order to arrive at the airport in time to satisfy the optimizations.

5. The computer-implemented method of claim 3, wherein the user context is a current activity of the user, and wherein the best start time is an activity end time at which the user is to complete or terminate the activity in order to satisfy the optimizations.

6. The computer-implemented method of claim 1, further comprising:
identifying a promotion associated with one of the resources, the promotion including a reward to the user or identifying a benefit, the promotion designed to entice the user to agree to a start time that further optimizes the multi-human activity scenario;
presenting the promotion to the user;
receiving, from the user, an acceptance or a non-acceptance of the promotion; and
updating the optimizations based on the received acceptance or non-acceptance.

7. The computer-implemented method of claim 6, further comprising:
determining that the user acceptance or non-acceptance has not been received in a threshold period of time; and
updating the optimizations based on non-acceptance.

8. The computer-implemented method of claim 1, further comprising:
providing notifications to the user at plural times;
wherein the notifications include one or more of reminders to the user of an upcoming use of the multi-human activity scenario, one or more suggested or current start times associated with the use, and offers of promotions associated with the resource of the multi-human activity scenario, the promotions being promoted to gain user acceptance of a change to a start time; and
wherein the notifications are provided by at least one of website messages, emails, SMS messages, phone calls, dedicated application notifications, or push notifications.

9. The computer-implemented method of claim 1, further comprising:
receiving the user preferences through one or more of an app, a sight, a personal identification card, a web page, or by voice.

10. The computer-implemented method of claim 1, wherein the user preferences include special requirements.

11. The computer-implemented method of claim 6, further comprising:
training a learning engine, the training using received user preferences and historical information; and
using information from the learning engine when generating promotions.

12. The computer-implemented method of claim 1, wherein the user preferences include:
time-of-use preferences, including day-of-week and time-of-day preferences;
preferred transportation routes;
preferred transportation methods;
preferred resources;
preferred time allocations for additional activities;
special needs; and
tolerances for waiting in lines and being provided with free time;
wherein the user preferences are optionally weighted by the user.

13. The computer-implemented method of claim 1, wherein the optimizations provide best station orders, an optimized flow, reduced costs, and an improved user experience, and wherein goals of the optimizations include creating an optimized queue and reducing bottlenecks.

14. A system comprising:
memory storing user preferences, user contexts and optimized queues; and
a server performing operations comprising:
receiving, over a computer network, user preferences associated with a user, wherein the user preferences include user-desired conditions and constraints of participation by the user in a multi-human activity scenario;
storing the user preferences in an electronic database;
receiving, over the computer network, a user context associated with the user;
accessing, by one or more processors, resource information for resources associated with the multi-human activity scenario, each resource to be used by, or available to, the user and the other users during participation in the multi-human activity scenario;
generating, by the one or more processors and based on the stored user preferences, the received user context, and the accessed resource information, an optimized queue for the multi-human activity scenario, the optimized queue including a start time for the user and start times for other users, wherein the optimized queue is generated based on current loads of the resources and expected times of use of the resources by the user and the other users, wherein the optimized queue includes, for a given resource-user pair, one or more sets of locations, times, and events, each event associated with a separate task of the user at a given resource; and
providing, to the user over the computer network, a schedule that includes the best start time and, for each resource assigned to the user, a time, a location, and an event schedule indicating mandatory, preferred and optional times and sub-locations of the events.

15. The system of claim 14, the operations further comprising:
receiving information associated with one or more of resource availability, staffing conditions of the resources, weather conditions associated with the multi-human activity scenario, traffic conditions for routes near or associated with the multi-human activity scenario, and a health condition of the user; and
wherein generating the optimized queue includes evaluating the information, including historical information, recent conditions, current conditions, and predicted conditions.

16. The system of claim 15, wherein the multi-human activity scenario is an airport;
wherein the best start time is a time at which the user is to leave for the airport;
wherein the resources include an airport facility, airline carriers using the airport facility, security gates at the airport facility, parking facilities, ground transportation, highways, and businesses; and
wherein generating the optimized queue further includes evaluating applicable ones of airline schedules, estimated airline arrivals and departures, parking availability information, airport personnel information, security gate information, ground transportation information, traffic information, and place-of-business information.

17. The system of claim 14, the operations further comprising:
identifying a promotion associated with one of the resources, the promotion including a reward to the user or identifying a benefit, the promotion designed to entice the user to agree to a start time that further optimizes the multi-human activity scenario;
presenting the promotion to the user;
receiving, from the user, an acceptance or a non-acceptance of the promotion; and
updating the optimized queue based on the received acceptance or non-acceptance.

18. A non-transitory computer-readable media encoded with a computer program, the program comprising instructions that when executed by one or more computers cause the one or more computers to perform operations comprising:
receiving, over a computer network, user preferences associated with a user, wherein the user preferences include user-desired conditions and constraints of participation by the user in a multi-human activity scenario;
storing the user preferences in an electronic database;
receiving, over the computer network, a user context associated with the user;
accessing, by one or more processors, resource information for resources associated with the multi-human activity scenario, each resource to be used by, or available to, the user and the other users during participation in the multi-human activity scenario;
generating, by the one or more processors and based on the stored user preferences, the received user context, and the accessed resource information, an optimized queue for the multi-human activity scenario, the optimized queue including a start time for the user and start times for other users, wherein the optimized queue is generated based on current loads of the resources and expected times of use of the resources by the user and the other users, wherein the optimized queue includes, for a given resource-user pair, one or more sets of locations, times, and events, each event associated with a separate task of the user at a given resource; and
providing, to the user over the computer network, a schedule that includes the best start time and, for each resource assigned to the user, a time, a location, and an event schedule indicating mandatory, preferred and optional times and sub-locations of the events.

19. The non-transitory computer-readable media of claim 18, the operations further comprising:
receiving information associated with one or more of resource availability, staffing conditions of the resources, weather conditions associated with the multi-human activity scenario, traffic conditions for routes near or associated with the multi-human activity scenario, and a health condition of the user; and
wherein generating the optimized queue includes evaluating the information, including historical information, recent conditions, current conditions, and predicted conditions.

20. The non-transitory computer-readable media of claim 19, wherein the multi-human activity scenario is an airport;
wherein the best start time is a time at which the user is to leave for the airport;
wherein the resources include an airport facility, airline carriers using the airport facility, security gates at the airport facility, parking facilities, ground transportation, highways, and businesses; and
wherein generating the optimized queue further includes evaluating applicable ones of airline schedules, estimated airline arrivals and departures, parking availability information, airport personnel information, security gate information, ground transportation information, traffic information, and place-of-business information.

21. The non-transitory computer-readable media of claim 18, the operations further comprising:
identifying a promotion associated with one of the resources, the promotion including a reward to the user and designed to entice the user to agree to a start time that further optimizes the multi-human activity scenario;
presenting the promotion to the user;
receiving, from the user, an acceptance or a non-acceptance of the promotion; and
updating the optimized queue based on the received acceptance or non-acceptance.
